(19) United States
(12) Patent Application Publication
(10) Pub. No.: US 2024/0166030 A1
(43) Pub. Date: May 23, 2024

(54) VEHICLE WINDOW SCREEN APPARATUS

(71) Applicant: Joseph MacSwain, Sherwood Park (CA)

(72) Inventor: Joseph MacSwain, Sherwood Park (CA)

(21) Appl. No.: 18/057,780

(22) Filed: Nov. 22, 2022

(51) Int. Cl. B60J 1/20

(52) U.S. Cl. CPC B60J 1/2011

(57) ABSTRACT

A window screen apparatus that is configured to be releasably secured over a window opening of a vehicle so as to inhibit objects from entering the passenger compartment of the vehicle when the window is in the open position. The window screen apparatus includes a screen member wherein the screen member is mateably shaped so as to cover the window opening of the vehicle. The screen member has secured to the perimeter edge thereof a first portion of the securing member. A second portion of the securing member is circumferentially disposed around the vehicle window opening within the passenger compartment. The first portion and second portion of the securing member are operable to releasably secure the screen member in position over the vehicle window opening. An access hatch is formed in the screen member having a fastener that facilitates an ability for an object to be passed therethrough.

### FIELD OF THE INVENTION

The present invention relates generally to vehicle window accessories, more specifically but not by way of limitation, a vehicle window screen apparatus that is releasably secured within a passenger compartment of a vehicle adjacent to a window so as to prevent objects such as but not limited to bugs from entering the passenger compartment of the vehicle when the window is in the down position.

### BACKGROUND

As is known in art, all vehicles have windows in the doors thereof. These windows are operable to move between an up position and a down position. Many drivers during periods of nice weather have a preference to drive with at least the driver window down so as to enjoy the fresh air while driving. Drivers of both commercial vehicles, such as but not limited to tractor trailer drivers, and conventional passenger vehicles do assume some risk when driving with the windows in the down position.

During driving with the windows in the down position, drivers take the risk of exposing themselves to objects such as but not limited to bugs or debris that can enter the window area when the window is down. Drivers that drive for long periods of time in certain areas can encounter bugs such as but not limited wasps which can enter the car through the window area and potentially harm the driver. Additionally, some commercial drivers must wait at locations for long periods of time wherein it is desirable to place the windows in the down position while parked. Without any type of protection, bugs such as but not limited to bees and the like may enter the window area when the window is in the down position.

It is intended within the scope of the present invention to provide a window screen apparatus for a vehicle window wherein the present invention includes a screen member that is releasably secured adjacent to a window of a vehicle wherein the screen member inhibits objects from traversing therepast into the passenger compartment of the vehicle.

### SUMMARY OF THE INVENTION

It is the object of the present invention to provide a vehicle window screen apparatus that is releasably secured adjacent to a vehicle window wherein the present invention includes a securing member.

Another object of the present invention is to provide a vehicle window screen configured to inhibit objects from entering the vehicle when the window is in the down position wherein the securing member includes a first portion positioned around the perimeter edge of the window area of the vehicle within the passenger compartment thereof and a second portion secured adjacent the perimeter edge of the screen member.

A further object of the present invention is to provide a vehicle window screen apparatus that is releasably secured adjacent to a vehicle window wherein the present invention includes a screen member.

Still another object of the present invention is to provide a vehicle window screen configured to inhibit objects from entering the vehicle when the window is in the down position wherein the screen member is sized so as to cover the window area of the vehicle.

An additional object of the present invention is to provide a vehicle window screen apparatus that is releasably secured adjacent to a vehicle window wherein the screen member has secured thereto the second portion of the securing member at the perimeter edge thereof.

Yet a further object of the present invention is to provide a vehicle window screen configured to inhibit objects from entering the vehicle when the window is in the down position wherein the screen member is further configured with an access hatch.

Another object of the present invention is to provide a vehicle window screen apparatus that is releasably secured adjacent to a vehicle window wherein the access hatch provides a space for a driver to reach therethrough while the screen member is installed.

An alternate object of the present invention is to provide a vehicle window screen configured to inhibit objects from entering the vehicle when the window is in the down position wherein the screen member is manufactured from nylon mesh screen material.

Still a further object of the present invention is to provide a vehicle window screen apparatus that is releasably secured adjacent to a vehicle window wherein the access hatch is located in a lower corner of the screen member and can employ a fastener such as but not limited to a zipper to provide operation thereof.

An additional object of the present invention is to provide a vehicle window screen configured to inhibit objects from entering the vehicle when the window is in the down position wherein the screen member is provided in alternate sizes so as to cover window openings of different sizes.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a front view of the screen member of the present invention; and

FIG. 2 is a perspective view of the first portion of the securing member positioned adjacent to a window of a vehicle; and

FIG. 3 is a perspective view of the present invention installed onto an exemplary vehicle window.

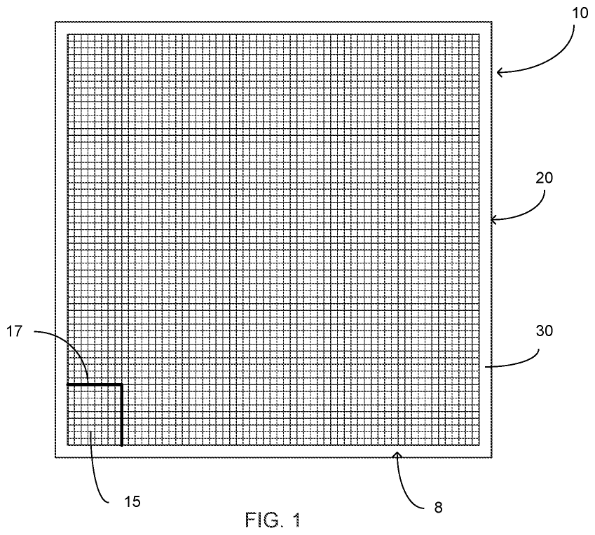

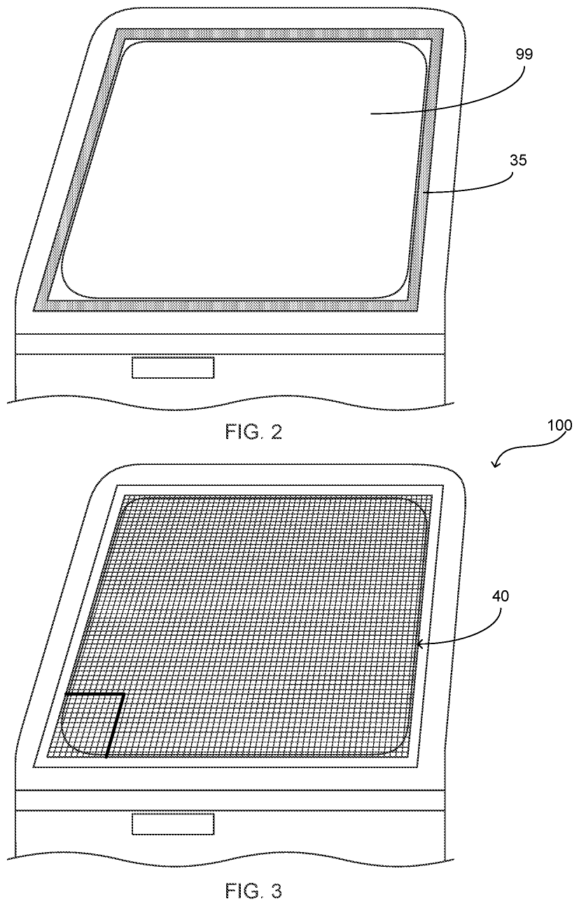

### DETAILED DESCRIPTION

Referring now to the drawings submitted herewith, wherein various elements depicted therein are not necessarily drawn to scale and wherein through the views and figures like elements are referenced with identical reference numerals, there is illustrated a window screen apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted herewith, the window screen apparatus 100 includes a screen member 10. The screen member 10 is planar in manner and manufactured from a nylon mesh material having a multitude of apertures allowing air to pass therethrough while inhibiting objects from entering inside a vehicle to which the window screen apparatus 100 is secured. The screen member 10 includes an access hatch 15 wherein the access hatch 15 includes fastener 17 that provides the ability to release or partially release the access hatch 15 from the screen member 10. In a preferred embodiment the access hatch 15 is placed proximate the lower edge 8 of the screen member 10. The access hatch 15 functions to allow a user of the window screen apparatus 100 to receive or pass through an object while the screen member 10 is in position adjacent the window of the vehicle. While various conventional fasteners could be employed to make fastener 17, in a preferred embodiment of the present invention the fastener 17 is manufactured from a zipper.

The screen member 10 includes perimeter edge 20 wherein the perimeter edge 20 has secured thereto a first portion 30 of the securing member 40. The securing member 40 includes a first portion 30 and a second portion 35 wherein the first portion 30 is configured to releasably secure to the second portion 35. The first portion 30 is secured to the screen member 10 proximate the perimeter edge 20 utilizing suitable durable techniques. The second portion 35 of the securing member 40 is secured adjacent the vehicle window opening 99 and is circumferentially disposed thereto. It is contemplated within the scope of the present invention that alternate types of material could be employed for the first portion 30 and second portion 35 such as but not limited to hook and loop material. It should be further understood within the scope of the present invention that the screen member 10 is sized and shaped so as to mateably cover the window opening 99.

While the access hatch 15 is illustrated in a particular position herein, it is contemplated within the scope of the present invention that the access hatch 15 could be located in alternate positions. Furthermore, it is contemplated within the scope of the present invention that the screen member 10 could have more than one access hatch 15. The second portion 35 is secured in position utilizing suitable durable techniques such as but not limited to chemical adhesion. In use, the second portion 35 of the window screen apparatus 100 is secured so as to be circumferentially disposed around the vehicle window 99. The screen member 10 is placed adjacent to the vehicle window 99 and the first portion 30 is secured to the second portion 35 so as to maintain position of the screen member 10 over the vehicle window. If desired, a user may utilize the access hatch 15 to receive and/or pass an object therethrough while the screen member 10 is in position over the vehicle window opening 99.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding description is, therefore, not intended to be limited to the specific forms set forth herein, but on the contrary, it is intended to cover such alternatives, modifications, and equivalents, as can be reasonably included within the spirit and scope of the invention.

What is claimed is:

1. A vehicle window screen apparatus that is configured to cover a vehicle window opening wherein the vehicle window screen apparatus comprises:
a screen member, said screen member being planar in manner, said screen member having an outer perimeter edge, said screen member being mateably shaped to the vehicle window opening;
a securing member, said securing member having a first portion and a second portion, said first portion of said securing member being secured to said screen member proximate the outer perimeter edge thereof, said first portion of said securing member being disposed completely around said outer perimeter edge of said screen member, said second portion of said securing member being circumferentially disposed around the vehicle window opening within a passenger compartment of a vehicle, said first portion and said second portion of said securing member configured to mateably secure to each other so as to maintain the screen member over the vehicle window opening.

2. The vehicle window screen apparatus that is configured to cover the vehicle window opening as recited in claim 1, and further including an access hatch, said access hatch being formed in said screen member proximate a lower edge thereof.

3. The vehicle window screen apparatus that is configured to cover the vehicle window opening as recited in claim 2, wherein said access hatch includes a fastener, said fastener configured to provide opening and closing of said access hatch.

4. The vehicle window screen apparatus that is configured to cover the vehicle window opening as recited in claim 3, wherein said screen member is manufactured from a nylon mesh material.

5. The vehicle window screen apparatus that is configured to cover the vehicle window opening as recited in claim 4, wherein said screen member is provided in alternate sizes.
